(19) United States
(12) Patent Application Publication
(10) Pub. No.: US 2018/0314707 A1
(43) Pub. Date: Nov. 1, 2018

(54) GEOGRAPHIC USER INTERACTION SYSTEM

(71) Applicant: WINKERS, INC., PORTLAND, OR (US)

(72) Inventor: QUAN NGUYEN, PORTLAND, OR (US)

(21) Appl. No.: 15/964,630

(22) Filed: Apr. 27, 2018

Related U.S. Application Data
(60) Provisional application No. 62/492,516, filed on May 1, 2017.

(51) Int. Cl. G06F 17/30; G06F 21/62

(52) U.S. Cl. CPC G06F 17/3087; G06F 17/30241; H04W 4/029; G06F 21/6254; G06F 21/6263

(57) ABSTRACT

A method of locating a user in a community of users includes receiving, from a user device, a signal indicating that a first user has launched program code on the user device, accessing a server computing device containing user data and using information from the user device to identify the first user, and including a user-defined proximity for the first user, retrieving a position of the first user from a global positioning system and locale information, accessing a location server computing device to retrieve geographic information relating to the locale including a map, determining, from the server computing device, other users in the community of users that have positions within the user-defined proximity, and displaying, on a user interface on the user device, the other users within the user-defined proximity.

### RELATED APPLICATIONS

This application is a continuation of, and claims priority to, U.S. Provisional Patent Application No. 62/492,516, filed May 1, 2017, incorporated by reference here in its entirety.

### BACKGROUND

Social media applications (apps) such as Facebook®, and LinkedIn®, allow users to post information and share with selected other users. Users may ‘check-in’ at locations, and try to sort out who is near them by the other users' posts, but have no means to see where the other users are relative to them on a map. Some social media connection apps allow users to communicate with people who are near them, but can only surmise that the person is near because the app connects only users who are within a predetermined range.

For users who are trying to connect with other users, and to see what other users are around them, the ability to use a map that shows that information would be invaluable. Similarly, it would be convenient for users to selectively remove themselves from other users' views, by blocking them, or becoming anonymous or invisible.

### BRIEF DESCRIPTION OF THE DRAWINGS

FIG. 1 shows an embodiment of a system having users identified by mobile devices on a map.

FIG. 2 shows an embodiment of a map displaying other users.

FIG. 3 shows an embodiment of a map display more detailed information about another user

FIG. 4 shows an embodiment of a map filter.

FIG. 5 shows an embodiment of an anonymous user on a map.

FIG. 6 shows an embodiment of a proximity radius for a user.

FIG. 7 shows an embodiment of a setting to adjust the proximity radius.

FIG. 8 shows an embodiment of a user having a different radius.

FIG. 9 shows a privacy setting for blocking and hiding.

FIG. 10 shows a listing of user characteristics for users within the radius.

FIG. 11 shows a listing of users within the radius and their distances.

FIG. 12 shows an example of a hide/block setting for a user on the map.

FIG. 13 shows an example of a messaging aspect.

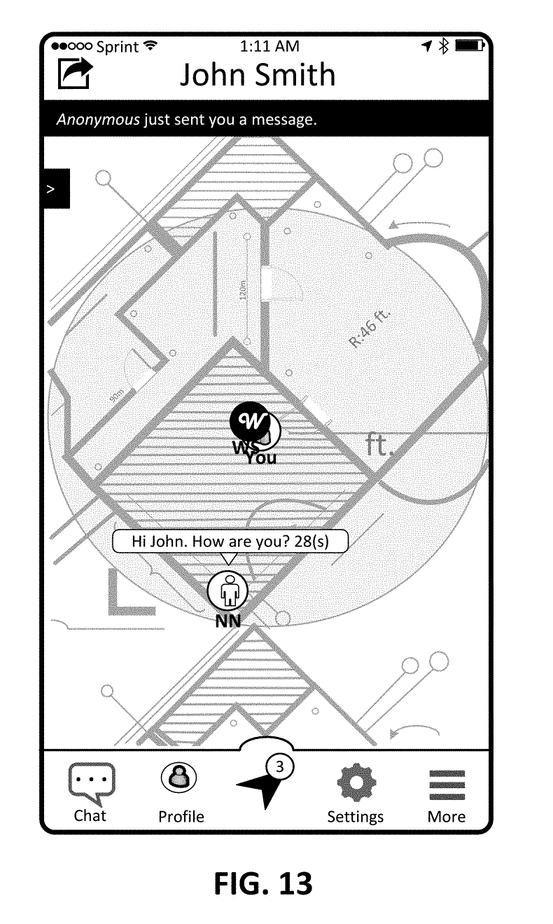

FIG. 14 shows a map with users, places and events all in one interface.

### DETAILED DESCRIPTION OF THE EMBODIMENTS

The following discussion is not intended to limit application of the embodiments of the invention, but is merely provided to aid understanding. A user attends a large conference that involves tens, if not hundreds, of companies and hundreds, if not thousands, of people. In addition to attending meetings at the conferences, several of these companies and individuals may use this opportunity to meet and do business, as well as connect with people on a more ad hoc basis.

Using the embodiments here, a user can access a map of the venue that shows other users, their profiles, and their position in the venue. The user can not only go to another user's location; the user can view the person's profile and send a message. The user can also block other users from seeing them, or become anonymous so other users can see the location indicator but do not see the person's information.

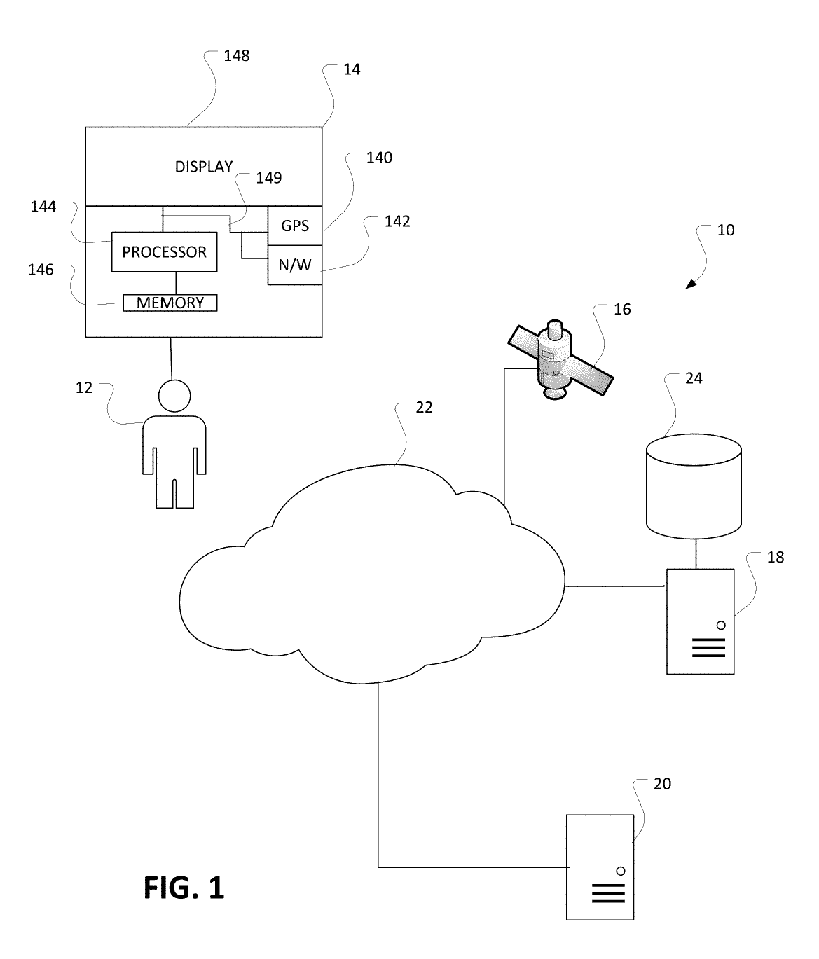

FIG. 1 shows an embodiment of a system 10 for locating users within a proximity of another user in a location. User 12 has a portable electronic computing device 14 such as a smart phone, tablet, laptop, or notebook computer. The computing device 14 may include one or more processors 144 that may be configured to communicate with and are operatively coupled to some peripheral subsystems via bus subsystem 149. These peripheral subsystems may include a storage subsystem/memory 146, one or more user input devices, in this embodiment a touch screen as part of the display 148, which also provides a user output interface, a network interface, also referred to as an adapter 142, and a Global Positioning System transmitter/receiver.

The bus subsystem 149 may provide a mechanism for enabling the various components and subsystems of computing device 14 to communicate with each other. Although FIG. 1 shows bus subsystem 149 as a single bus, alternative embodiments of the bus subsystem may utilize multiple busses.

The network interface 142 may provide an interface to other device systems and networks. The network interface 142 may serve as an interface for receiving data from and transmitting data to other systems from the computing device 14. The network interface 142 may include a wireless interface that allows the device 14 to communicate across wireless networks through a wireless access point, and may also include a cellular connection to allow the device to communicate through a cellular network. The network interface will allow the computing device 14 to communicate with one or more servers such as 18 and 20, and system data storage 24.

The device data store/memory 146 may include one or more separate memory devices. It may provide a computer-readable storage medium for storing the basic programming and data constructs that may provide the functionality of at least one embodiment of the disclosure here. The data store 146 may store the applications, which include programs, code modules, and instructions, that, when executed by one or more processors, may provide the functionality of one or more embodiments of the present disclosure. The data store 146 may comprise a memory and a file/disk storage subsystem. In addition, the computing device 14 may store data on another computer such as server 18 accessible through the network 22 via the network interface 142.

The device may also include separate control buttons, or may have integrated control buttons into the display if the display consists of a touch screen. The device in this embodiment has a touch screen and possibly one or more buttons, not shown, on the periphery of the touch screen/display 148. Alternative user input devices may include buttons, a keyboard, pointing devices such as a mouse, trackball, touch pad, etc. In general, the use of the term ‘input device’ is intended to encompass all possible types of devices and mechanisms for inputting information into the device 14.

User output devices, in this embodiment the display/touch screen 148, may include all display subsystems, audio output devices, etc. The output device may present user interfaces to facilitate user interaction with applications performing processes described here and variations.

The discussion here refers to ‘servers’ or ‘server computing devices.’ In general, the server referred to here is a server computing device with a processor and a memory that operates on the user information and provides information back to the users relating to other users in the community of users that subscribe to the same service. Typically, there will be an application server computing device and a global positioning service server that will communicate with the user device or the server. Many of the functions described here may be performed by the application server, the user device, the GPS server. No limitation of any function being performed by one of the devices is intended nor should it be implied.

In the environment of the system 10 the computing device 14 may be a client device. The network may consist of any appropriate network, including an intranet, the Internet, a cellular network, a local area network, a satellite network, or any other such network and/or combination of these. Components used for such a system can depend at least in part upon the type of network and/or environment selected. Protocols and components for communicating via such a network are well known and will not be discussed here in detail. Wired or wireless connections, or combinations of these, may enable communication over the network. In the embodiments here, the network includes the Internet and/or cellular communications. The application server 18 receives the requests and serves information in response to those requests via the network 22.

The application server 18 in combination with data store 24, or by itself, may consist of multiple servicers, layers or other elements, processors, or components, which may be chained, clustered, or otherwise configured, performs the tasks such as interacting with the client computing device and the data store 24. In some embodiments, some or all of the data store 24 may be housed in or integrated with the application servicer 18. Servers, as used here, may be implemented in various ways, such as hardware devices or virtual computer systems. Server may refer to a programming module executed on a computing system. The term ‘data store’ refers to any device or combination of devices capable of storing, accessing, and retrieving data. This may include any combination and number of data servers, databases, data storages devices and media, in any standard, distributed, or clustered environment.

The application server 18 may include any appropriate hardware, software, and firmware for integrating with the data store as needed to execute aspects of one or more applications for the client device, handling some or all the data access and logic for an application. The application server may provide access control services in cooperation with the data store and is able to generate content including, but not limited to, text, graphics, audio, video and/or other content usable to be provided to the user, which may be served to the user by the web server in the form of HyperText Markup Language (“HTML”), Extensible Markup Language (“XML”), JavaScript, Cascading Style Sheets (“CSS”), or another appropriate client-side structured language.

Content transferred to a client device such as 14 may be processed by the client device to provide the content in one or more forms including, but not limited to, forms that are perceptible to the user audibly, visually and/or through other senses including touch, taste, and/or smell. The handling of all requests and responses, as well as the delivery of content between the client device 14 and the application server 18, can be handled by the web server using PHP: Hypertext Preprocessor (“PHP”), Python, Ruby, Perl, Java, HTML, XML, or another appropriate server-side structured language in this example. It should be understood that the web and application servers are not required and are merely example components, as structured code discussed herein can be executed on any appropriate device or host machine as discussed elsewhere herein. Further, operations described herein as being performed by a single device may, unless otherwise clear from context, be performed collectively by multiple devices, which may form a distributed and/or virtual system.

The data store 24 can include several separate data tables, databases, data documents, dynamic data storage schemes and/or other data storage mechanisms and media for storing data relating to an aspect of the present disclosure. For example, the data store illustrated may include mechanisms for storing temporary data and general data storage. The data store also is shown to include a mechanism for storing alert data, which can be used to generate one or more alerts as described above. It should be understood that there can be many other aspects that may need to be stored in the data store, such as page image information and access rights information, which can be stored in any of the above listed mechanisms as appropriate or in additional mechanisms in the data store 24. The data store 24 is operable, through logic associated therewith, to receive instructions from the application server 18 and obtain, update, or otherwise process data in response thereto. The application server 18 may provide static, dynamic or a combination of static and dynamic data in response to the received instructions. Dynamic data, such as data used in web logs (blogs), data streams, and other such applications may be generated by server-side structured languages as described herein or may be provided by a content management system (“CMS”) operating on, or under the control of, the application server.

Each server typically will include an operating system that provides executable program instructions for the general administration and operation of that server and typically will include a computer-readable storage medium, such as a hard disk, random access memory, read only memory, etc., storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure here.

The environment can include a variety of data stores and other memory and storage media as discussed above. These can reside in a variety of locations, such as on a storage medium local to (and/or resident in) one or more of the computers or remote from any or all the computers across the network. In a set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen or keypad) and at least one output device (e.g., a display device, printer, or speaker). Such a system may also include one or more storage devices, such as disk drives, optical storage devices and solid-state storage devices such as random-access memory (“RAM”) or read-only memory (“ROM”), as well as removable media devices, memory cards, flash cards, etc.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 1. Thus, the depiction of the system 10 in FIG. 1 should be taken as being illustrative in nature and not limiting to the scope of the disclosure.

When the user activates, or launches, program code associated with the application discussed in these embodiments, the program code coordinates the device's location devices such as the GPS, Wi-Fi, Bluetooth, and a third-party Indoor Location API to determine the current location of the device and the user, which is transmitted to one or more application servers 18. During the location coordination process, the program code interacts with the device's GPS component to acquire the GPS location from one or more GPS satellites such as 16 and use it to determine the best relative location of the device before sending it to the application server. An application server is the server that executes the code and stores the data associated with the location application under discussion here. The application server 18, upon receiving notification that a user has signed in or become active in the system, uses the location coordinates, such as latitude and longitude, of the user to locate other users who are within the proximity set by the app user.

The system locates a first user in a community of users, such as subscribed users to a service. When a user activates the application or program code on a user device, it sends a signal to a server computing device. The server computing device contains user data that identifies the first user and the user-defined proximity radius. The system retrieves the position of the first user from the user device directly or from a global positioning system server. The server also includes locale information. Local information is information about the area around the user, such as a building or map. This will more than likely involve accessing a location server computing device to retrieve geographic information relating to the locale including a map either at that point or having been previously accessed. The system then determines other users in the community of users that have positions within the user-defined proximity. This information is then displayed on a user interface on the user device of the first user, the other users superimposed on a map of the locale.

Locating other users here means that the system performs a search in the system using an algorithm to find other active users, map users, in a region and calculate the distance between these users and the app user using their location coordinates. The system then checks against the privacy settings of all the users in the proximity to make sure they want to be exposed in that proximity before sending them to the app user. The system also checks the app user's filters to ensure that only users that match the app users' filters criteria will be sent to the app user. When the app user receives location coordinates of the map users and their information from the server, the program code then overlays those coordinates and their associated information on layout.

A layout is more than just a map. For example, if one uses an application that locates users, such as Waze® or Google Maps®, the application shows the location of a user in a city grid. Even if the user were in a building, the location is shown with streets and geographical features such as rivers, mountains, etc. The application here identifies the user's location, and then associates that location with a building, a venue, or the streets mentioned above, all of which will be referred to as a venue, with the layout of the venue drawn as background to the user. For example, the user may be in an exhibition hall that has fixed elements, such as restaurants or coffee shops around the perimeter. The layout would include those fixed elements, allowing people to see the user's location relative to those elements. When users are trying to meet up in a large, crowded venue, the layout becomes invaluable.

The information for the layout may come from many sources. The application here could contain a library of venues and their associated layouts, keyed to GPS coordinates of the elements of the layout. The application may access another application server such as 20 for the layouts that has an application programming interface that provides the building layouts and notifies the application when a user enters a venue that has a provided layout.

One should note that except for the GPS signals used by the application server, all information transmitted and received goes through the network 22 and the application server, no exposure of any phone numbers or email addresses occurs when users communicate through the application. None of this information used to identify users has any private elements other than what the user chooses to expose.

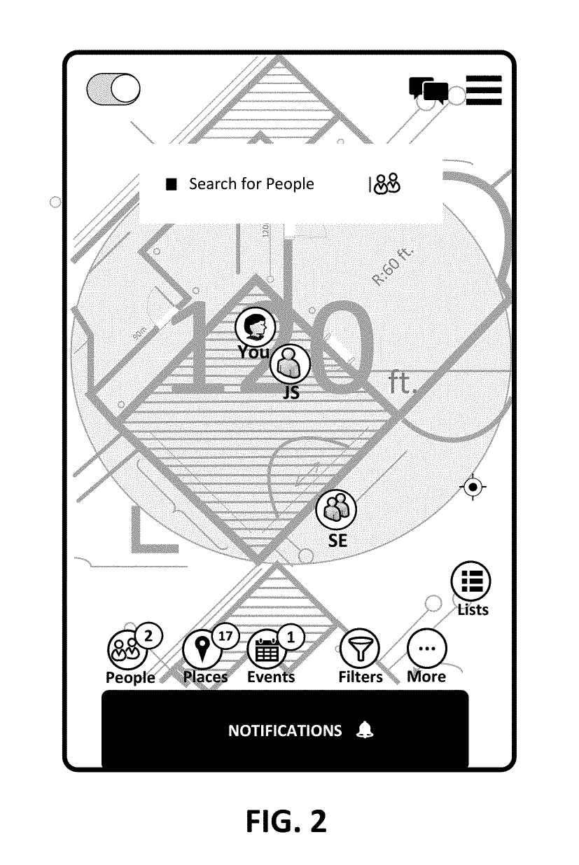

FIG. 2 shows an example of a map where a user (“You”) is surrounded by other users using the application. The grey lines behind the user give the outline of the building or venue in which the user currently stands or sits. The vertical lines indicate the streets. The user can see that one identified user, JS, is nearby and another user, SE is in the proximity of the user. The user can use the application to contact the other users nearby with a quick contact referred to here as a ‘connect request.’

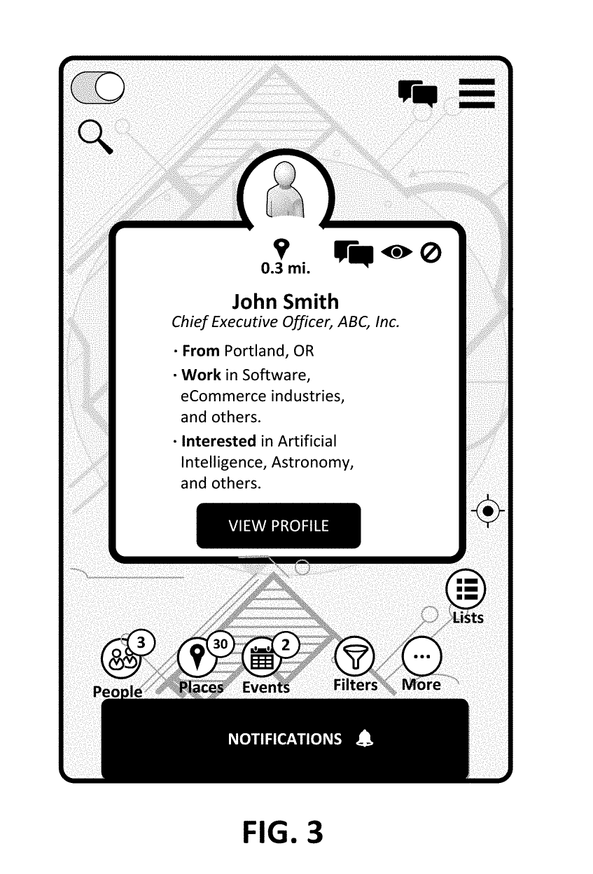

In making contact, all the contacts will be through the application. The user's phone number, email, etc. will not be exposed by the contact. One of the many advantages of this application lies in allowing the users to have control over many different aspects of their privacy. The only information exposed to other users comes from whatever that user selects by a user profile. FIG. 3 shows an example of a user profile for the nearby user, John Smith.

In the user's profile shown in FIG. 3, one can see the user's name, age, interests, etc. For business users, one could include the company name, position, etc. The bottom of the screen shows that when the user selects the individual to see that user's profile, it occurs under networking. At the bottom of the profile window, there are choices for sending a connection request, shown as the sideways semicolon, sending a message, or viewing more details of the user's profile. The viewing user can also close the window by clicking outside of the profile window. This information is stored and associated with the user in the storage 22 from FIG. 1.

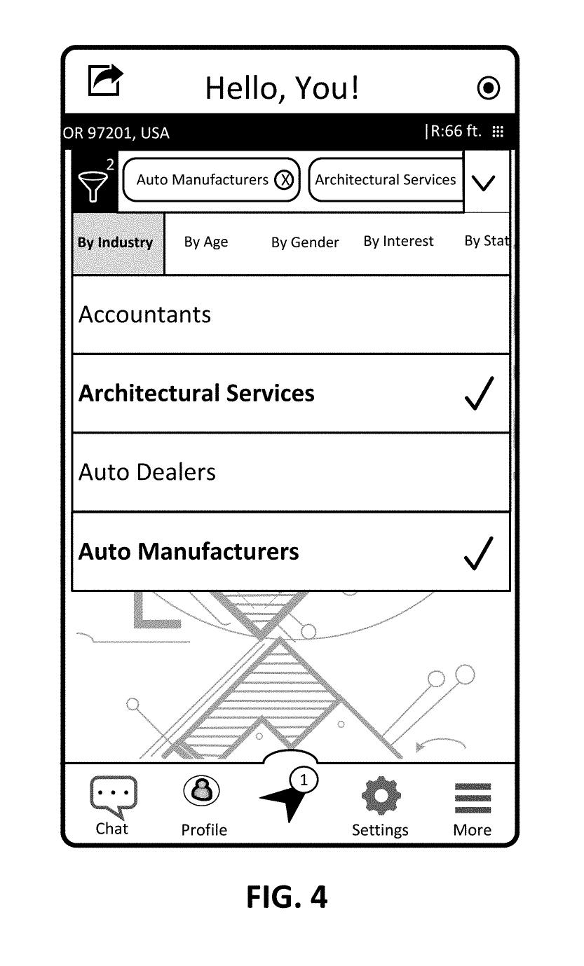

While FIGS. 1 and 2 show a limited number of users, but one could imagine that the You user may have several hundred users in their proximity. The user may want to filter the users shown on the map. They could select gender, company, job, interest, etc. This will reduce the number of users viewable by the You user. FIG. 4 shows a use of filtering by types of business with which other users may be affiliated, such as Architectural Services and Auto Manufacturers.

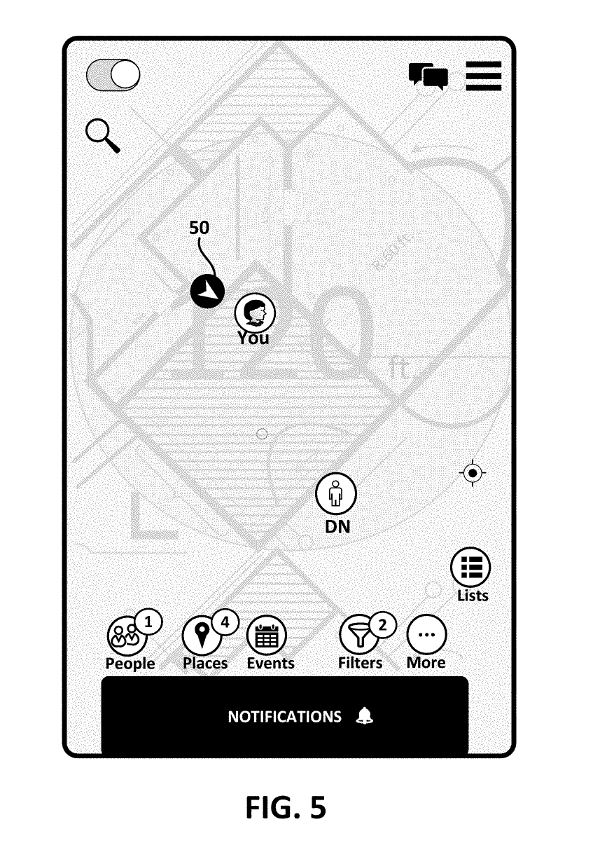

On the other side of the viewing, users can become anonymous, as shown in FIG. 5. Users may not want other users to see them on the map, or access the information that would otherwise be available to them. If someone launches the application on that person's portable device, typically the person would be prompted to log in. If that person logs in and becomes a user, that person's information will become available on the application for other users, unless the newly logged in user become anonymous or is hiding. However, a unique aspect of this system is that the user can choose to be anonymous with the user's identity hidden and still be able to use the system within the allowable capabilities. That person remains anonymous and can see how many other users in the proximity. Currently, anonymous users can see other users' information and send them messages, except for when other users filter them out. In FIG. 5, the anonymous user is shown as a navigation arrow 50. However, all their actions with other anonymous and registered users remain anonymous and are not retained in the system. Once the user turns off their anonymous mode, that user gets full functionality and access to all the other users' information, for users that have not chosen to block the first user.

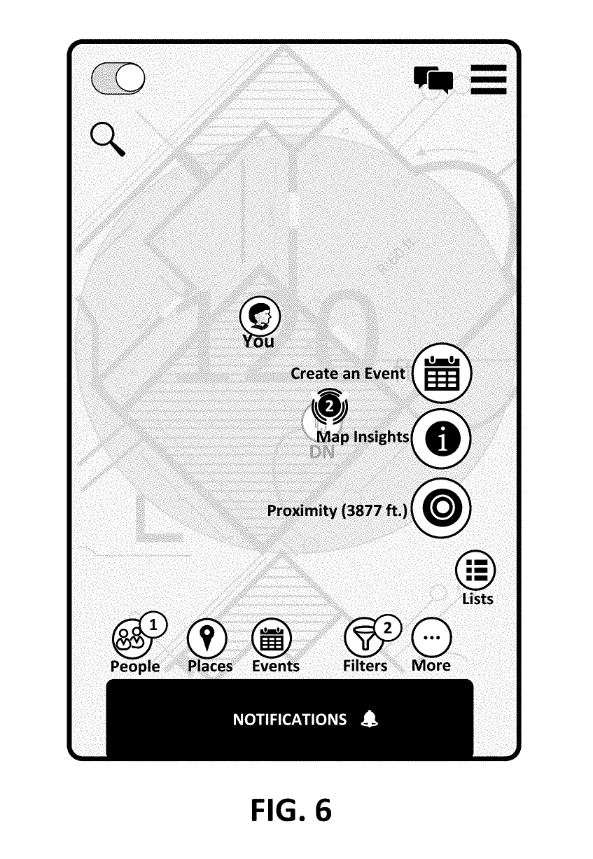

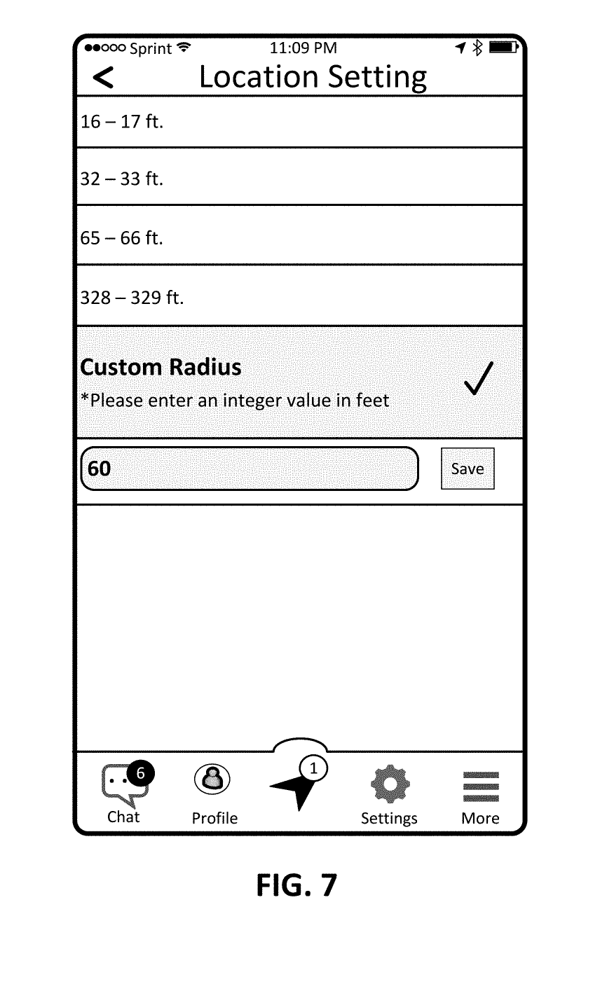

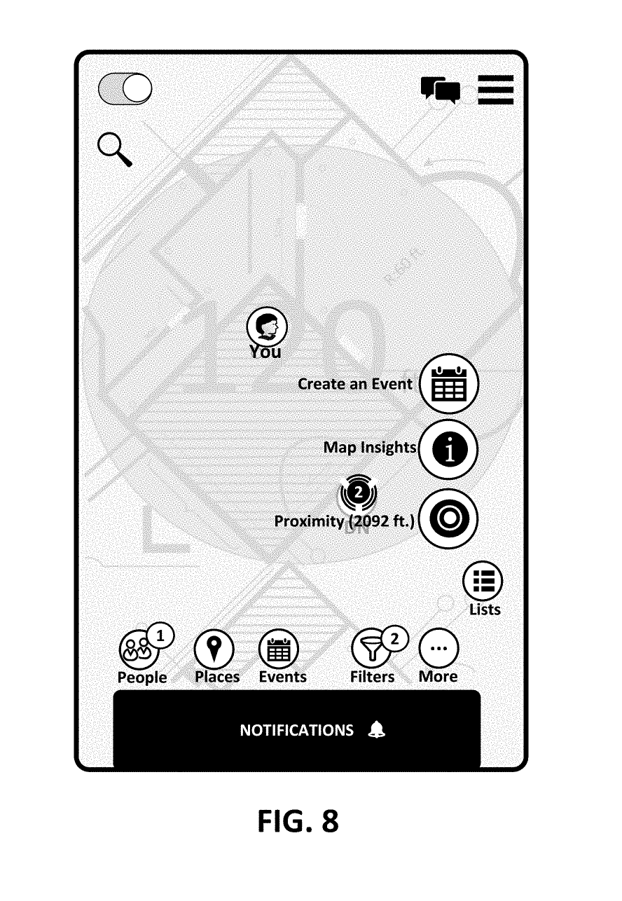

Another control element provided to the user involves the proximity radius. A user can select a proximity radius that controls a distance within which other users can be seen. The user can select how large of a radius to use. FIG. 6 shows the You user's location and the current radius. FIG. 7 shows the screen with the user's radius in the Tools menu. FIG. 8 shows the result of selecting Update Proximity Radius. While some preset radii are provided, the user can select a custom radius.

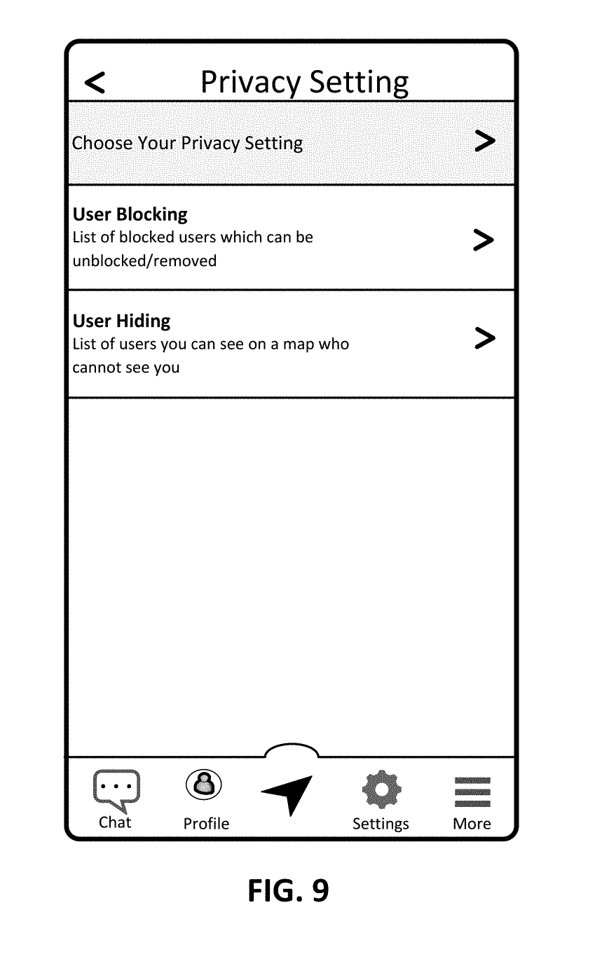

In addition to the ability to filter users and define a proximity radius, the user can block other users from being able to see the user as shown in FIG. 9. The user can block and unblock people. When a person is blocked, it stops the blocking user from seeing that person and prevents the blocked user from being able to contact the blocking user. Another tool allows the user to hide from other users. Hiding prevents the other user from seeing the hidden user, but the hiding user can see the other users on the map.

In this manner, the user can see the geographical positions of other users around them in a venue or region. The user has control of the radius in which he/she selects other users to be displayed on his/her map or to display him/her on their map, and can selective block or hide from other users, as well as operate anonymously.

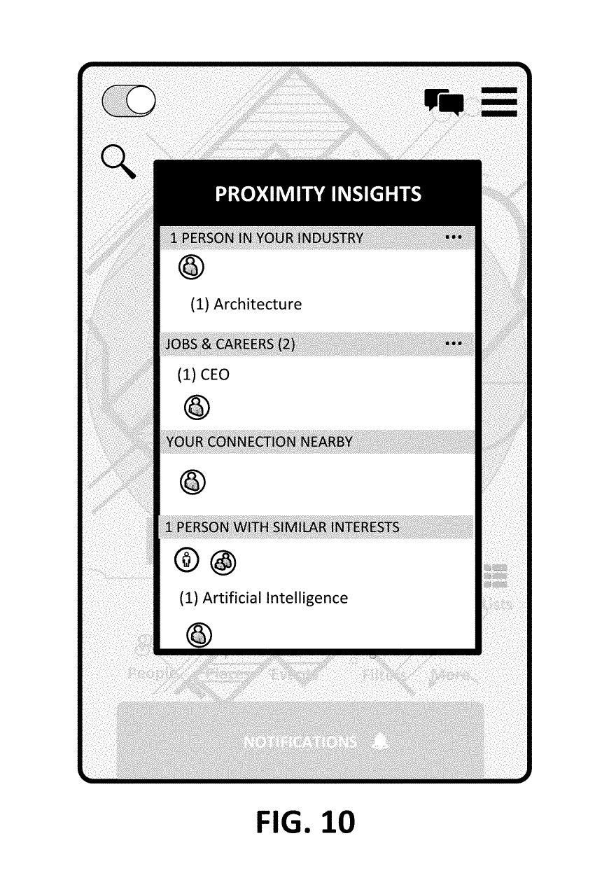

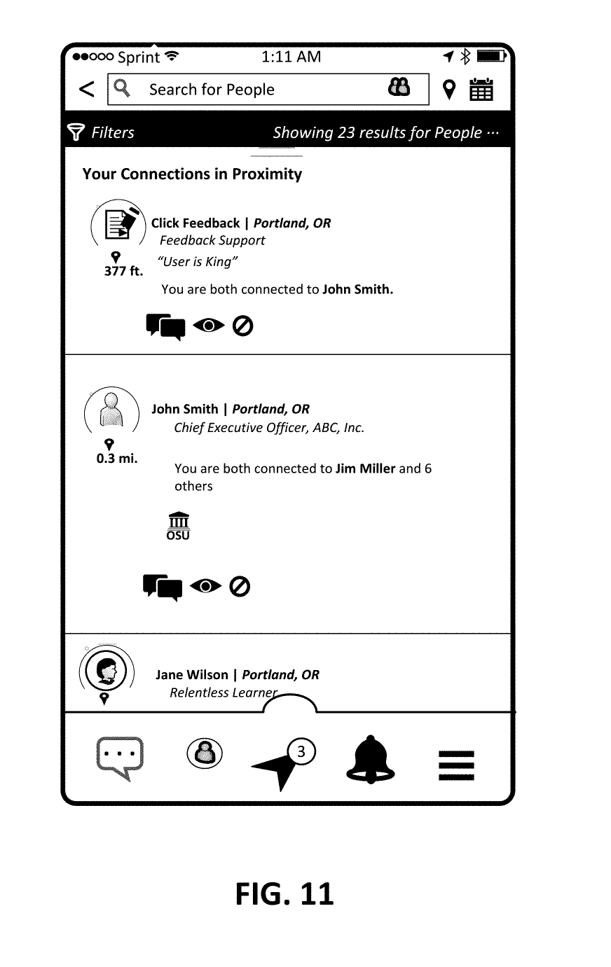

In addition to controlling the distance at which other users can be seen by the You user, the proximity allows the system to provide insights and push notifications. FIG. 10 shows an example of a list of local users that identifies them by their industry, job, connections to the You user, or by similar interests. As shown in FIG. 11, the user can view people in the user's proximity who are connected to the You user. The system performs this type of breakdown for the users in the You user's proximity.

The system provides intelligent insights about other users when sending their information to the You user. These insights may come in the form of a message displayed in the user's list of items. The system may also use a push notification when the other user crosses into the You user's proximity radius. The system takes the profile of each of the other users and looks for similarities in skills, interests, mutual connections between the You user and the other users. When a new user enters the proximity, the same push notification happens for the new user to the You user.

For example, a user could receive a push message from the system, “JOHN SMITH from PORTLAND, OR, just entered your proximity” A more detailed notification may occur for users “Your connection, from PORTLAND, OR, who is also connected to ACME PRODUCTS, and JOHN SMITH, recently entered the proximity you have been within the last 3 hours and 45 minutes.”

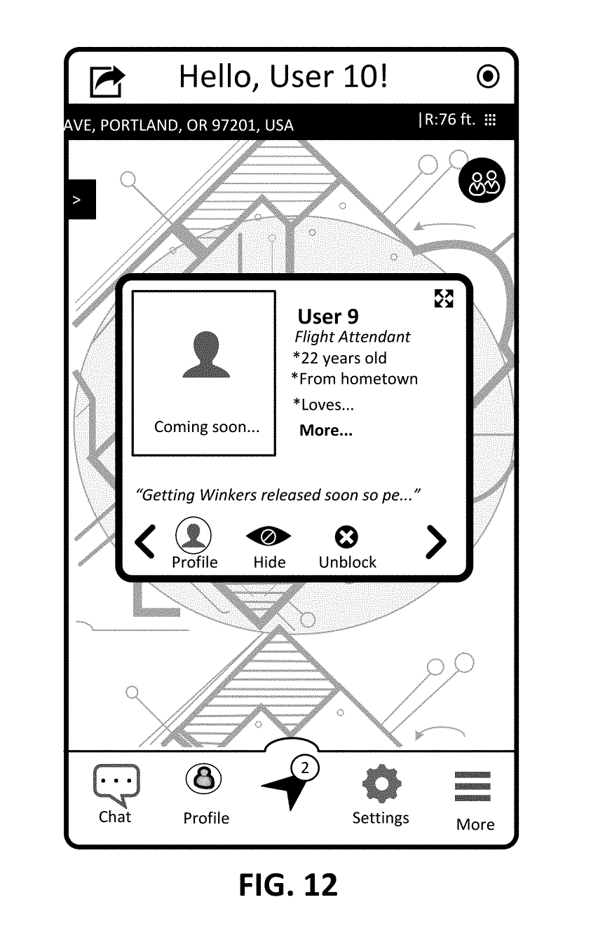

When the You user wants to connect with one of the users with whom the user shares a connection, the You user can select the person by tapping their icon and the You user will see that user's profile. This is shown in FIG. 12. The two users can use messaging within the application to allow communication without necessarily sharing other information that the users wish to keep private for now.

In addition to being able to view other users on the map, the system may provide the user a list view of the users within the proximity. The user can apply filters to select users with attributes the You user wants to see. The implementation of the filtering system allows the users to see the map of other users with granular details about the skills, interests, etc., and knowing when to provide more information.

Another aspect of the filtering implementation is that it has ‘sticky’ content. When a user applies a filter to the users in the list or map view, the filters are saved so that the user can use them the next time the user opens the application to access the system. This ensures that the users only see what they want to see based on their previous selections.

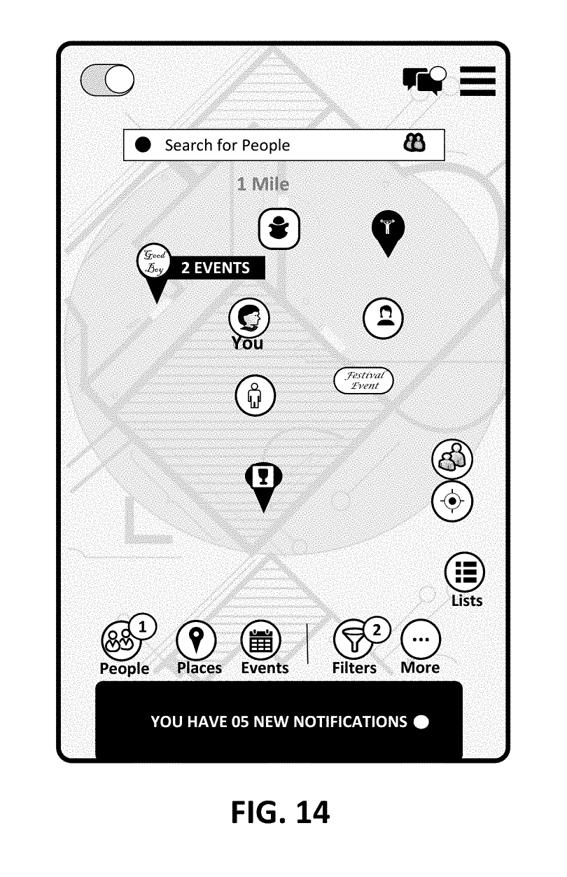

In addition to users, the system may also display events, people and places on one map, as shown in FIG. 14. This provides a system where users can enhance their networking experience by having visibility into places and events that are in their proximity. This provides the user with more information to help the user decide how and where to best spend the user's time. As mentioned before, the people, events and places could be viewed on the map or in a list view.

Another aspect of events is the events on the go. The system allows users to create short-term upcoming events where people want to quickly gather a group of people to discuss a new topic, work on a project, meet and greet, etc. A user can select an event button on their interfaces to start an event scheduling. Users can invite people on their connection lists to join or the system will allow them to broadcast the events to other people who may be interested that are in proximity the user and have matching or similar interests based on their profiles and the system's matching process.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the above discussion and the attached claims

What is claimed is:

1. A computer-implemented method of locating a user in a community of users, comprising:
receiving, from a user device, a signal indicating that a first user has launched program code on the user device;
accessing a server computing device containing user data and using information from the user device to identify the first user, and including a user-defined proximity for the first user;
retrieving a position of the first user from a global positioning system and locale information;
accessing a location server computing device to retrieve geographic information relating to the locale including a map;
determining, from the server computing device, other users in the community of users that have positions within the user-defined proximity; and
displaying, on a user interface on the user device, the other users within the user-defined proximity.

2. The computer-implemented method of claim 1, further comprising:
receiving a signal from the user device identifying a second user in the community of users to whom the first user wants to connect; and
displaying information for the second user on the user interface of the user device of the first user.

3. The computer-implemented method of claim 2, further comprising using the server computing device to route messages between the first user and the second user.

4. The computer-implemented method of claim 1, further comprising:
receiving a signal from any user in the community of users indicating that the user wants to become hidden; and
preventing information of the user from being displayed on devices of at least one other user in the community of users.

5. The computer-implemented method of claim 4, wherein the at least one other user is one user.

6. The computer-implemented method of claim 4, wherein the at least one other user is all users.

7. The computer-implemented method of claim 1, further comprising:
receiving a signal from any user in the community of users indicating that the user wants to be anonymous; and
allowing the user to see other users in the community, but preventing other users from gathering any information about the user.

8. The computer-implemented method of claim 1, further comprising:
receiving a signal from any user in the community to identify a user as a blocked user; and
preventing the blocked user from being able to contact the user.

9. The computer-implemented method of claim 1, further comprising:
receiving a signal from the first user to apply a filter to other users in the community; and
displaying only those other users in the community that meet the requirements of the filter.

10. The computer-implemented method of claim 1, wherein displaying the other users within the user-defined proximity comprises sending a message about each user, the message including information based upon similarities in at least one of skills, interests, connections, and associations.

11. The computer-implemented method of claim 1, wherein displaying the other users comprises display one of either a map or a list.

12. The computer-implemented method of claim 1, further comprising applying a user-defined filter that identifies other users based upon criteria selected by the user, and then displaying only those users who meet those criteria.

13. The computer-implemented method of claim 12, wherein the user-defined filter is saved on the user device such that the filter is applied whenever the user launches the program code on the user device.

14. The computer-implemented method of claim 1, further comprising displaying at least one of events and places within the user-defined proximity on the user interface.

15. The computer-implemented method of claim 1, further comprising:
displaying on the user interface an event icon;
in response to a signal form the user indicating the user has pressed the event icon, providing the user with a user interface to allow the user to define an event and a list of users to be invited to the event; and
sending out messages to the list of users containing information about the event.

16. The computer-implemented method of claim 15, further comprising allowing the user to indicate that the event is to be broadcast across the community of users and then sending a broadcast message to the community of users.
